(19) United States
(12) Patent Application Publication
(10) Pub. No.: US 2007/0166114 A1
(43) Pub. Date: Jul. 19, 2007

(54) Orienting means for condom transport equipment

(76) Inventor: James R. Whitten, Albany, GA (US)

Correspondence Address: ROGERS TOWERS, P.A., 1301 RIVERPLACE BOULEVARD, SUITE 1500, JACKSONVILLE, FL, 32207, US

(21) Appl. No.: 11/528,046

(22) Filed: Sep. 27, 2006

Related U.S. Application Data
(60) Provisional application No. 60/753,546, filed on Dec. 23, 2005.

(51) Int. Cl. B65G 51/00

(52) U.S. Cl. 406/198

(57) ABSTRACT

The invention comprises an orientation tube having a plurality of protrusions or projections disposed on the interior of the tube, the protrusions being shaped and sized so as to temporarily retard or slow the forward progress of the condom ring, such that the condom closed nipple end and main body is drawn ahead of the condom ring open end during passage through the tube no matter what the orientation of the condom is upon entry into the tube. The protrusions are grouped in annularly oriented sets, with multiple sets spaced along the length of the tube. The protrusions are preferably rounded such that no corners or edges are encountered by the condom ring.

This application claims the benefit of U.S. Provisional Patent Application Ser. No. 60/753,546 filed Dec. 23, 2005.

### BACKGROUND OF THE INVENTION

This invention relates generally to the field of condom handling and transport equipment used in the manufacture, testing and packaging of condoms, and more particularly relates to condom handling and transport equipment where condoms are individually transported through tubular devices from one processing station or operation to another. Even more particularly, the invention relates to orientation means whereby randomly oriented condoms are oriented during transport delivery such that all condoms are similarly oriented upon delivery.

In the manufacturing and packaging of condoms, it is often necessary to transport condoms individually from one processing station or operation to the next. For example, every condom must be individually tested prior to packaging, and automatic equipment to accomplish this task exists in the industry. Untested condoms are typically delivered to the testing equipment as a large, randomly oriented mass of hundreds of condoms from which individual condoms are successively removed. One automatic method for gathering and delivering individual condoms involves the use of a suction pick-up device, the pick-up device pulling a single condom from the batch and delivering it to a transport tube or hose. The condom is then drawn by suction or vacuum means through the tube or hose and delivered to handling mechanisms which mount the condom onto a testing mandrel. It is important that each condom be delivered in the same orientation regarding the relative position of the open rolled end to the closed nipple end so that the handling mechanisms can load the condom onto the mandrel. In a known system, the transport tube or hose is sized such that the rolled end or ring of the condom encounters the interior walls of the tube or hose as it is pulled through. Friction or drag effects resulting from contact between the tube or hose and the condom ring cause the closed nipple end to be drawn ahead of the condom ring, regardless of the initial orientation of the condom as it enters the tube or hose, such that all condoms are ultimately delivered in the same orientation. Examples of condom handling, transport and testing equipment can be seen in U.S. Pat. Nos. 5,478,193, 5,499,898, 5,564,552, 5,971,690, 6,160,406, 6,394,258, 6,588,989 and 6,611,149, the disclosure of which is incorporated herein by reference.

A problem with this system results from the fact that powdered cornstarch or similar material is applied to the condoms to prevent adhesion of the condoms to each other and to reduce friction and adhesion between the condoms and the handling and testing equipment. It has been found that the efficiency of the condom ring drag method for orienting the condoms within the transport tube or hose diminishes over time due to a build-up of powder on the inner walls of the tube or hose. It is an object of this invention is to provide an orientation means for the condoms that is not adversely affected by the powder, whereby the individual condoms are similarly oriented by the orientation means during transport or delivery within tubular conduits. It is an object of this invention to provide an improved orientation means that utilizes frictional or drag effects to properly orient the randomly presented condoms.

### SUMMARY OF THE INVENTION

The invention comprises an orientation tube having a plurality of protrusions or projections disposed on the interior of the tube, the protrusions being shaped and sized so as to temporarily retard or slow the forward progress of the condom ring, such that the condom nipple end and main body is drawn ahead of the condom ring during passage through the tube. The protrusions are grouped in annularly oriented sets, with multiple sets spaced along the length of the tube. The protrusions are preferably rounded such that the condom ring encounters no corners or edges as it passes through the orientation tube. The protrusions disrupt the smoothness of the tubular inner wall such that the effectiveness of the orientation means is not diminished due to the build-up of powder on the tubular inner wall.

### BRIEF DESCRIPTION OF THE DRAWINGS

FIG. 1 is an external view of the orienting tube showing a condom prior to entry and a condom exiting in the proper orientation.

FIG. 2 is a external view of the orienting tube with the protrusions shown as exposed.

FIG. 3 is a cross-sectional view of FIG. 2 taken along line A-A.

FIG. 4 is an end view of the orienting tube, showing protrusion members with a rounded configuration.

FIG. 5 is an end view of the orienting tube, showing an alternative embodiment of the protrusion members, the protrusion members comprising gapped annularly oriented ridges.

### DETAILED DESCRIPTION OF THE INVENTION

With reference to the drawings, the invention will now be described in detail with regard for the best mode and the preferred embodiment. In general, the invention is an orientation means for a condom transport or delivery device or system that utilizes suction or negative pressure to move individual condoms within tubular conduits, whereby randomly oriented condoms entering the orientation means are oriented such that all condoms exiting the orientation means are oriented in the same direction or manner relative to the open end and closed end of the condom.

The orientation means comprises an elongated tube member 10 having an inlet end 11 and a discharge end 12. The inner diameter of the tube member 10 is dependent upon the size of the condom 90 being delivered, or more specifically the size of the condom rolled end or ring 91, as such will vary. The tube 10 may be composed of metal, plastic or other material with similar properties. The tube 10 is most preferably rigid and straight, but may be flexible and/or curved if necessary. The tube 10 is typically incorporated as part of a more extensive tubular transport or delivery system wherein suction, vacuum or negative pressure is applied to the tube 10 such that condoms 90 disposed within the tube 10 are drawn therethrough.

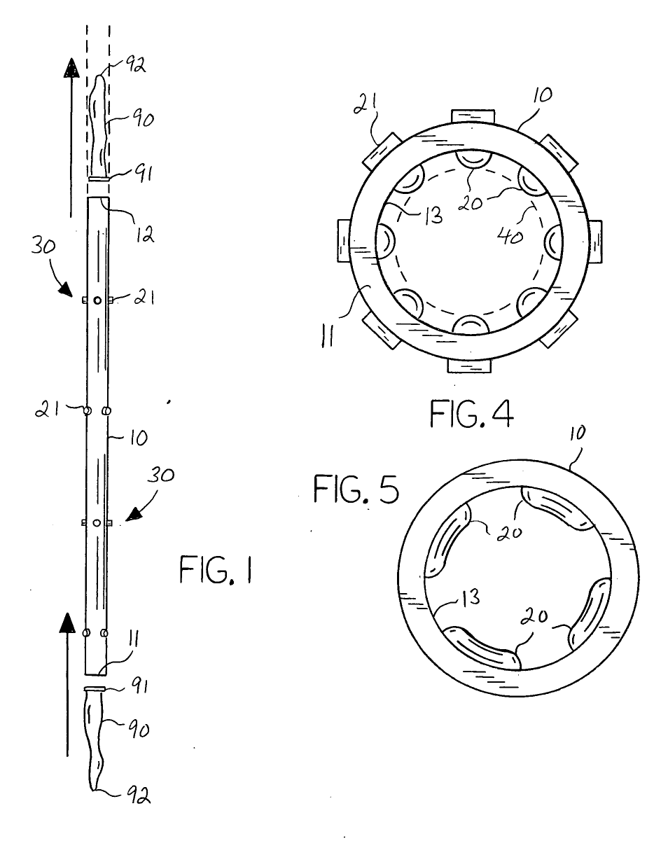

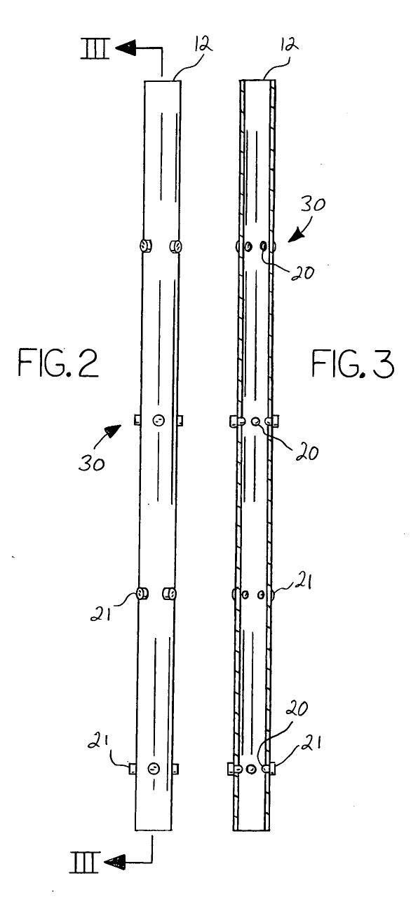

Individual or discrete protrusion or projection retardation members 20 are disposed at multiple locations on the interior surface 13 of the tube member 10, and may be composed of metal, plastic or similar suitable material. The protrusion members 20 act to retard or slow the forward progress of the condom ring 91 as the condom 90 is drawn through the tube 10, such that the condom nipple or closed end 92 is ultimately pulled ahead of the condom ring or open end 91 by the suction force, as shown in FIG. 1. The protrusion members 20 are preferably grouped in sets 30, with each set 30 being oriented annularly or radially on the tube inner surface 13. The exposed portion of the protrusion member 20 is most preferably rounded or hemispherical such that no corners, edges or similar abrupt structures are encountered by the condom 90 during passage through the tube 10. As shown in FIGS. 1 through 4, the protrusion members 20 may each comprise a body 21 that extends through the wall of the tube member 10, the protrusion members 20 being mounted in apertures provided in the tube member 10. Most preferably, the protrusion members 20 are discrete elements separated annularly by gaps, but it is contemplated that the protrusion member 20 could also consist of elongated annularly oriented gapped ridges, as shown in FIG. 5, or a single annular ridge or ring that extends completely about the inner circumference of the tube member 10.

Preferably, the sets 30 of protrusion members 20 are spaced axially along the tube 10 a sufficient distance whereby the full length of the condom 90 can extend between the sets 30 of protrusion members 20. Preferably, each set 30 comprises at least two protrusion members 20 that are symmetrically spaced, with four or more protrusion members 20 in each set 30 being even more preferable. The sets 30 of protrusion members 20 may be disposed such that the protrusions 20 in different sets 30 are not axially aligned, as shown in FIGS. 1 through 4.

As a representative example, it has been found that a suitable construction for the invention for a condom 90 having a ring end 91 outer diameter of slightly more than one inch has a tube member 10 extending approximately eight feet in length with an inner diameter or approximately 1.25 inches, having sets 30 comprising four protrusion members 20, with each protrusion member having a spherical shape and extending approximately one eighth inch from the interior surface 13, whereby the protrusion members 20 define an artificial inner diameter 40 for the set 30 of approximately one inch, with each set 30 being separated approximately eight to 8.5 inches axially.

In this manner, as each condom 90 is drawn into the inlet end 11 of the tube member 10, the axial velocity of the condom ring 91, having an outer diameter of slightly greater dimension than the artificial inner diameter 40 defined by each set 30 of protrusion members 20, is slightly retarded or temporarily slowed by contact with each set 30, such that over the length of the tube member 10 the condom nipple end 92, which is not impeded by the protrusion members 20, is ultimately drawn fully forward of the condom ring 91. Each condom 90 exits the tube member 10 oriented with the nipple closed end 92 forward and the condom ring open end 91 rearward. In practice, the discharge end 12 of the tube member 10 will be connected to a transport hose or the like that delivers the properly oriented condom 90 to further handling or processing mechanisms.

It is understood and contemplated that equivalents and substitutions for certain elements set forth above may be obvious to those skilled in the art, and therefore the true definition and scope of the invention is to be as set forth in the following claims.

I claim:

1. A condom orienting device orienting individual condoms, each condom having an open ring end and a closed nipple end, the device comprising an elongated tube member having a plurality of protrusion members disposed internally on said tube member, whereby the protrusion members retard the forward progress of the condom open ring end as the condom is drawn through the tube member such that the condom is drawn from the tube member with the condom closed nipple end preceding the condom open ring end regardless of the orientation with which the condom is drawn into the tube member.

2. The device of claim 2, wherein said plurality of protrusions members are arranged in sets.

3. The device of claim 3, wherein said plurality of protrusions members are arranged annularly in sets.

4. The device of claim 2, wherein said sets are axially spaced within said tube member.

5. The device of claim 3, wherein said sets are axially spaced within said tube member.

6. The device of claim 1, wherein said protrusion members are rounded.

7. The device of claim 2, wherein said protrusion members are rounded.

8. The device of claim 3, wherein said protrusion members are rounded.

9. The device of claim 4, wherein said protrusion members are rounded.

10. The device of claim 5, wherein said protrusion members are rounded.

11. The device of claim 1, wherein said protrusion members comprise annularly oriented ridges.

12. The device of claim 11, wherein said annularly oriented ridges are annularly separated.

13. The device of claim 4, wherein said sets of protrusion members are separated axially by a distance greater than the length of said condom.

14. The device of claim 5, wherein said sets of protrusion members are separated axially by a distance greater than the length of said condom.

15. In a tubular condom transport device delivering individual condoms each having an open ring end and a closed nipple end, the improvement comprising disposing a plurality of protrusion members internally within said tubular condom transport device, whereby the protrusion members temporarily retard the forward progress of the condom open ring end as the condom is drawn through said tubular condom transport device such that the condom is delivered with the condom closed nipple end preceding the condom open ring end regardless of the orientation with which the condom is drawn into the tube member.

16. The device of claim 15, wherein said protrusion members are disposed in annularly oriented sets.

17. The device of claim 16, wherein said sets are axially separated.

18. The device of claim 17, wherein said protrusion members are rounded.

19. The device of claim 17, wherein said protrusion members are annularly oriented and separated ridges.

20. The device of claim 20, wherein said sets of protrusion members are separated axially by a distance greater than the length of said individual condom.
